(19) United States
(12) Patent Application Publication
(10) Pub. No.: US 2012/0223684 A1
(43) Pub. Date: Sep. 6, 2012

(54) VOLTAGE REGULATOR AND INTEGRATED CIRCUIT INCLUDING THE SAME

(76) Inventors: Sang-Hoon LIM, Seongnam-si (KR); Seung-Hyun An, Yongin-si (KR)

(21) Appl. No.: 13/355,722

(22) Filed: Jan. 23, 2012

(30) Foreign Application Priority Data
Mar. 4, 2011 (KR) 10-2011-0019436

(51) Int. Cl. G05F 1/10

(52) U.S. Cl. 323/268; 323/265

(57) ABSTRACT

A voltage regulator includes a power supply unit configured to generate a power supply voltage based on a reference voltage and a feedback voltage, configured to control a current level of a power supply line based on a first control signal, and configured to generate a driving signal based on a second control signal, the power supply voltage being provided to an external logic circuit through the power supply line, and the current level of the power supply line being additionally controlled outside the power supply unit based on the driving signal, and a feedback unit configured to generate the feedback voltage based on the power supply voltage, and configured to control a level of the feedback voltage based on a third control signal.

### BACKGROUND

1. Field

Example embodiments relate to a power supply, and more particularly to a voltage regulator and an integrated circuit including the voltage regulator.

2. Description of the Related Art

Typically, an integrated circuit includes a logic circuit performing a particular function and a power supply circuit for the logic circuit. The power supply circuit is required to supply stable power to another circuit regardless of an impedance variation of wiring between the power supply circuit and the other circuit. A voltage regulator, which is a kind of the power supply circuit, may provide stable power regardless of output impedance. The voltage regulator may be included in various integrated circuits.

### SUMMARY

An embodiment is directed to a voltage regulator, including a power supply unit configured to generate a power supply voltage based on a reference voltage and a feedback voltage, configured to control a current level of a power supply line based on a first control signal, and configured to generate a driving signal based on a second control signal, the power supply voltage being provided to an external logic circuit through the power supply line, and the current level of the power supply line being additionally controlled outside the power supply unit based on the driving signal, and a feedback unit configured to generate the feedback voltage based on the power supply voltage, and configured to control a level of the feedback voltage based on a third control signal.

At least one of the first control signal, the second control signal and the third control signal may be activated when a level of the power supply voltage is lower than a threshold level.

The power supply unit may increase the current level of the power supply line when the first control signal is activated.

The power supply unit may activate the driving signal such that an external driver additionally increases the current level of the power supply line based on the activated driving signal when the second control signal is activated.

The feedback unit may decrease the level of the feedback voltage by varying a resistance of the feedback unit when the third control signal is activated.

The power supply unit may include a comparison unit configured to generate a comparison signal based on the reference voltage and the feedback voltage, and an output unit configured to generate the power supply voltage based on the comparison signal, configured to internally increase the current level of the power supply line based on the first control signal, and configured to generate the driving signal based on the second control signal.

The output unit may include a first driving unit configured to generate the power supply voltage based on the comparison signal and an input voltage, a second driving unit configured to provide an additional current to the power supply line based on the comparison signal and the input voltage when the first control signal is activated, and a driving signal generation unit configured to activate the driving signal based on the comparison signal when the second control signal is activated.

The second driving unit may include a first p-type metal oxide semiconductor (PMOS) transistor connected between the input voltage and the power supply line, and having a gate electrode, a first transmission gate configured to receive the comparison signal and connected to the gate electrode of the first PMOS transistor, and operating in response to the first control signal, and a second PMOS transistor connected between the input voltage and the gate electrode of the first PMOS transistor, and having a gate electrode receiving the first control signal.

The driving signal generation unit may include a second transmission gate configured to receive the comparison signal and connected to an output terminal of the driving signal, and operating in response to the second control signal, and a third PMOS transistor connected between the input voltage and the output terminal of the driving signal, and having a gate electrode receiving the second control signal.

The feedback unit may include a first resistor unit connected between the power supply line and a feedback node outputting the feedback voltage, a resistance of the first resistor unit being varied based on the third control signal, and a second resistor unit connected between the feedback node and a ground voltage.

The first resistor unit may include a first resistor connected to the feedback node, a second resistor connected between the first resistor and the power supply line, and a transmission gate connected in parallel with the second resistor between the first resistor and the power supply line, and operating in response to the third control signal.

Another embodiment is directed to an integrated circuit, including a voltage regulator configured to generate a power supply voltage based on a first reference voltage and a feedback voltage, configured to control a current level of a power supply line based on a first control signal, configured to generate a driving signal based on a second control signal, and configured to control a level of the feedback voltage based on a third control signal, the power supply voltage being provided to a logic circuit included in the integrated circuit through the power supply line, a voltage detector configured to generate a detection signal based on the power supply voltage and a second reference voltage, the detection signal indicating whether a level of the power supply voltage is lower than a threshold level, a regulator controller configured to generate the first control signal, the second control signal and the third control signal based on the detection signal, and a driver configured to additionally control the current level of the power supply line based on the driving signal.

The regulator controller may include a compensation unit configured to generate a compensation signal by reducing noise in the detection signal, and a control signal generation unit configured to generate the first control signal, the second control signal and the third control signal based on the compensation signal and a command signal.

The compensation unit may include a filter configured to periodically sample the detection signal, and configured to generate the compensation signal based on the sampled detection signal, the compensation signal corresponding to an average value or a median value of the sampled detection signal.

The control signal generation unit may include a determination unit configured to generate a first driving control signal, a second driving control signal and a third driving control signal based on the command signal and each of the first, second and third driving control signals indicating whether controlling the current level of the power supply line is to be performed and/or whether controlling the level of the power supply voltage is to be performed, and a logic operation unit configured to generate the first control signal, the second control signal and the third control signal by performing a logic operation on the compensation signal, the first driving control signal, the second driving control signal and the third driving control signal.

Another embodiment is directed to an integrated circuit, including a supply unit configured to receive a feedback voltage and a first reference voltage, and configured to generate a driving signal and a power supply voltage based on the first reference voltage and the feedback voltage, the power supply voltage being supplied to a power supply line, the driving signal being supplied to a driving signal line, and the feedback voltage being received on a feedback voltage line and being based on a voltage of the power supply line, a detector unit configured to sense a voltage on the power supply line at a location on the power supply line that is external to the supply unit, and configured to generate a detection signal based on the sensed voltage and a second reference voltage, a controller unit configured to receive the detection signal and, based on the detection signal, control at least one of a voltage on the feedback voltage line, a voltage on the driving signal line, and a voltage on the power supply line, logic circuits, the logic circuits being external to the supply unit, the power supply voltage being supplied from the supply unit to the logic circuits on the power supply line, and a driver unit, the driver unit being located apart from the supply unit and supplying a current on the power supply line at a location between the logic circuits and the supply unit, the current supplied by the driver unit to the power supply line being controlled by the voltage on the driving signal line.

The controller unit may control the voltage on the feedback voltage line, the voltage on the feedback voltage line being controlled by controlling operation of a voltage divider on the feedback voltage line.

The controller unit may control the voltage on the driving signal line.

The controller unit may control the voltage on the power supply line, the voltage on the power supply line being controlled by supplying additional current to the power supply line from an external source.

### BRIEF DESCRIPTION OF THE DRAWINGS

The above and other features will become more apparent to those of skill in the art by describing in detail exemplary embodiments with reference to the attached drawings, in which:

FIG. 1 illustrates a block diagram of a voltage regulator according to some example embodiments.

FIG. 2 illustrates a block diagram of an example of an output unit included in the voltage regulator of FIG. 1.

FIG. 3 illustrates a block diagram of an example of a feedback unit included in the voltage regulator of FIG. 1.

FIG. 4 illustrates a diagram of an example of the voltage regulator of FIG. 1.

FIG. 5 illustrates a diagram of another example of the voltage regulator of FIG. 1.

FIG. 6 illustrates a block diagram of an integrated circuit according to some example embodiments.

FIG. 7 illustrates a block diagram of an example of a voltage detector included in the integrated circuit of FIG. 6.

FIG. 8 illustrates a block diagram of an example of a regulator controller included in the integrated circuit of FIG. 6.

FIG. 9 illustrates a flow chart of an example of a method of operating the integrated circuit of FIG. 6.

FIG. 10 illustrates a flow chart of an example of operation 5400 in FIG. 9.

FIG. 11 illustrates a block diagram of an electronic system including the integrated circuit according to some example embodiments.

### DETAILED DESCRIPTION

Korean Patent Application No. 10-2011-0019436, filed on Mar. 4, 2011, in the Korean Intellectual Property Office, and entitled: “Voltage Regulator and Integrated Circuit Including the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be understood that, although the terms first, second, etc., may be used herein to describe various elements, these elements should not be limited by these terms. These terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 illustrates a block diagram of a voltage regulator according to some example embodiments.

In the example shown in FIG. 1, a voltage regulator 100 includes a power supply unit 110 and a feedback unit 120.

In the example shown in FIG. 1, the power supply unit 110 generates a power supply voltage VDD based on a reference voltage VREF and a feedback voltage VFB. The reference voltage VREF may be a stabilized voltage, and may be set such that the power supply voltage VDD corresponds to a target level. The feedback voltage VFB may be the power supply voltage VDD itself or a voltage obtained by dividing the power supply voltage VDD by a predetermined ratio.

In the example shown in FIG. 1, the power supply unit 110 controls a current level of a power supply line PL based on a first control signal CS1. The power supply voltage VDD is provided to an external logic circuit (not illustrated in FIG. 1) through the power supply line PL. The power supply unit 110 generates a driving signal DRV based on a second control signal CS2.

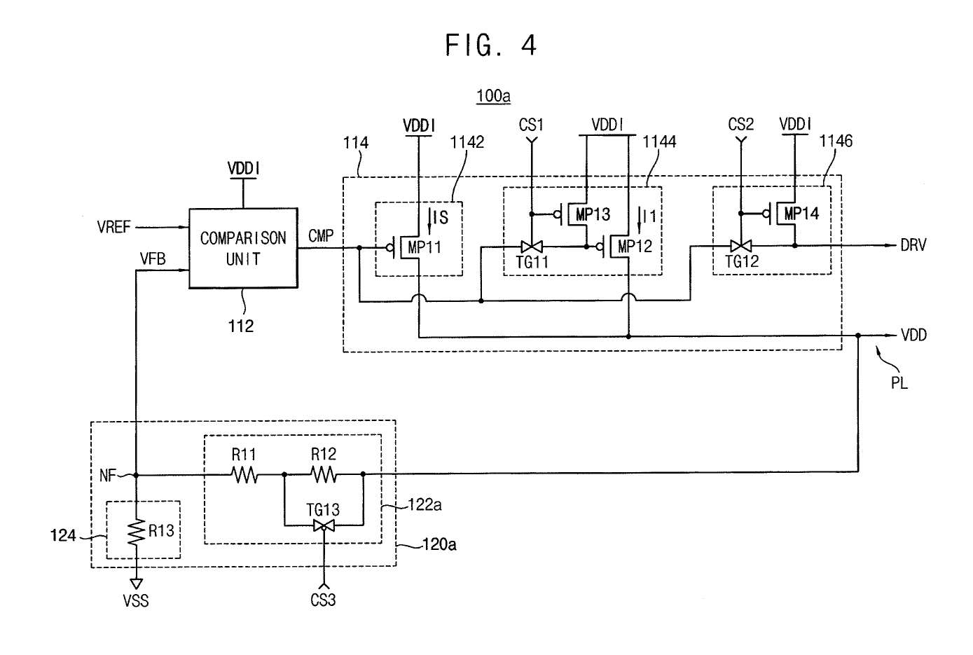

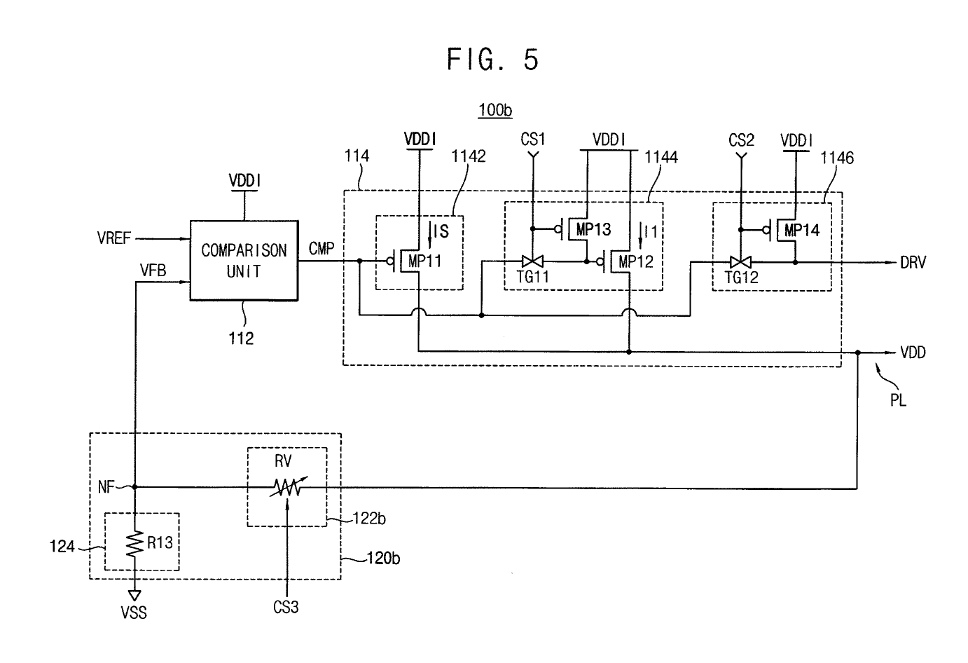

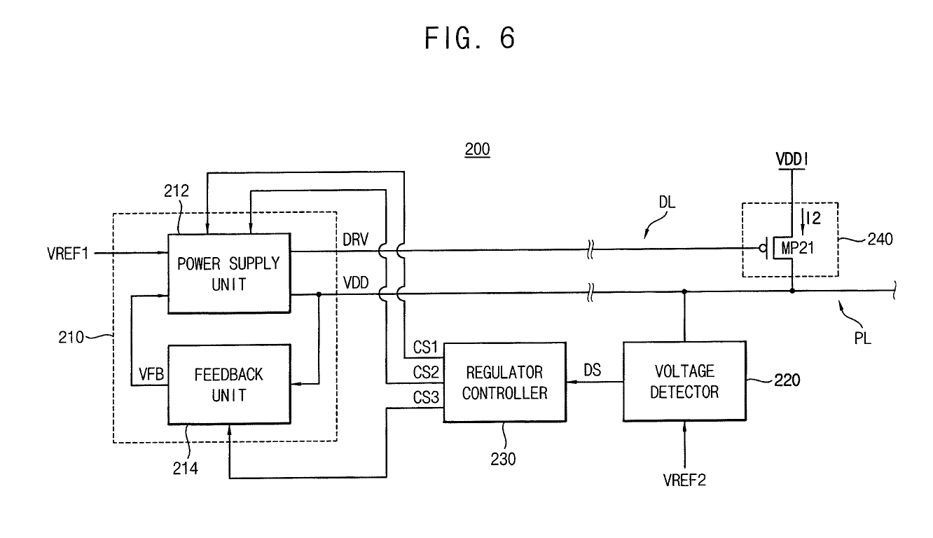

The current level of the power supply line PL may be additionally controlled outside the power supply unit 110, e.g., by using an external driver (not illustrated in FIG. 1), based on the driving signal DRV. When the first control signal CS1 and/or the second control signal CS2 is activated, the current level of the power supply line PL may be controlled. Example embodiments of controlling the current level of the power supply line PL based on the first control signal CS1 will be described below in detail with reference to FIGS. 4 and 5. Example embodiments of controlling the current level of the power supply line PL based on the second control signal CS2 will be described below in detail with reference to FIG. 6.

The power supply unit 110 may include a comparison unit 112 and an output unit 114.

The comparison unit 112 may generate a comparison signal CMP based on the reference voltage VREF and the feedback voltage VFB. For example, the comparison unit 112 may detect a difference between the reference voltage VREF and the feedback voltage VFB to generate the comparison signal CMP including information about variation of an output signal such as the power supply voltage VDD. The comparison unit 112 may include a differential amplifier, e.g., an error amplifier.

The output unit 114 may generate the power supply voltage VDD based on the comparison signal CMP, may internally increase the current level of the power supply line PL based on the first control signal CS1, and may generate the driving signal DRV based on the second control signal CS2. For example, the output unit 114 may provide a current to the power supply line PL based on the comparison signal CMP to induce the power supply voltage VDD, and may maintain a level of the power supply voltage VDD at a predetermined level. The output unit 114 may provide a first additional current to the power supply line PL based on the first control signal CS1 to increase a current flowing through the power supply line PL. The output unit 114 may activate the driving signal DRV based on the second control signal CS2 to enable the external driver (not illustrated in FIG. 1). As will be described below with reference to FIG. 6, the external driver may provide a second additional current to the power supply line PL based on the driving signal DRV to increase the current flowing through the power supply line PL.

In the example shown in FIG. 1, the feedback unit 120 generates the feedback voltage VFB based on the power supply voltage VDD, and controls a level of the feedback voltage VFB based on a third control signal CS3. For example, the feedback unit 120 may generate the feedback voltage VFB by dividing the power supply voltage VDD by the predetermined ratio, and may provide the feedback voltage VFB to the power supply unit 110. When the third control signal CS3 is activated, the feedback unit 120 may control the level of the feedback voltage VFB, and the power supply unit 110 may control the level of the power supply voltage VDD.

In an example embodiment, at least one of the first control signal CS1, the second control signal CS2 and the third control signal CS3 may be activated when the level of the power supply voltage VDD is lower than a threshold level. In another example embodiment, at least one of the first control signal CS1, the second control signal CS2 and the third control signal CS3 may be activated when the voltage regulator 100 receives a command signal having a predetermined instruction. The drivability of the voltage regulator 100 may be improved and/or the level of the power supply voltage VDD may be increased based on at least one activated control signal of the control signals CS1, CS2 and CS3.

Although not illustrated in FIG. 1, the voltage regulator 100 may further include a reference voltage generation unit that generates the reference voltage VREF. The reference voltage generation unit may be implemented with resistors used as a voltage divider for generating the reference voltage VREF. In case a more stable reference voltage is required, the reference voltage generation unit may be implemented with a band-gap reference voltage circuit. The band-gap reference voltage circuit may provide a stable reference voltage that is insensitive to temperature variation.

As an integrated circuit becomes more highly integrated, the number of logic circuits that are included in the integrated circuit and perforin particular functions increases, and total current consumed in the integrated circuit may also increase. The increase of the total current consumption may cause a voltage drop on a power supply line. If a level of the power supply voltage becomes lower than a minimum desired level, the logic circuits and the integrated circuit may malfunction. To reduce the total current consumption, a general integrated circuit includes a voltage regulator that is connected to a power supply line, which is formed to have a relatively low resistance by increasing a width of the power supply line. However, such a general integrated circuit may be limited with respect to increasing integration density due to the power supply line having a relatively large width.

In the voltage regulator 100 according to some example embodiments, the power supply unit 110 controls the current level of the power supply voltage PL based on the first control signal CS1. For example, the power supply unit 110 may provide the first additional current to the power supply line PL based on the first control signal CS1. The power supply unit 110 generates the driving signal DRV based on the second control signal CS2. The external driver (not illustrated) may provide the second additional current to the power supply line PL based on the driving signal DRV. In addition, the feedback unit 120 controls the level of the feedback voltage VFB based on the third control signal CS3, and the power supply unit 110 may effectively control the level of the power supply voltage VDD. Thus, a current flowing through the power supply line PL may increase without increasing a width of the power supply line PL, and the level of the power supply voltage VDD may increase. The voltage regulator 100 may have a relatively high drivability and may effectively supply stable power (e.g., the power supply voltage VDD) to logic circuits included in the integrated circuit.

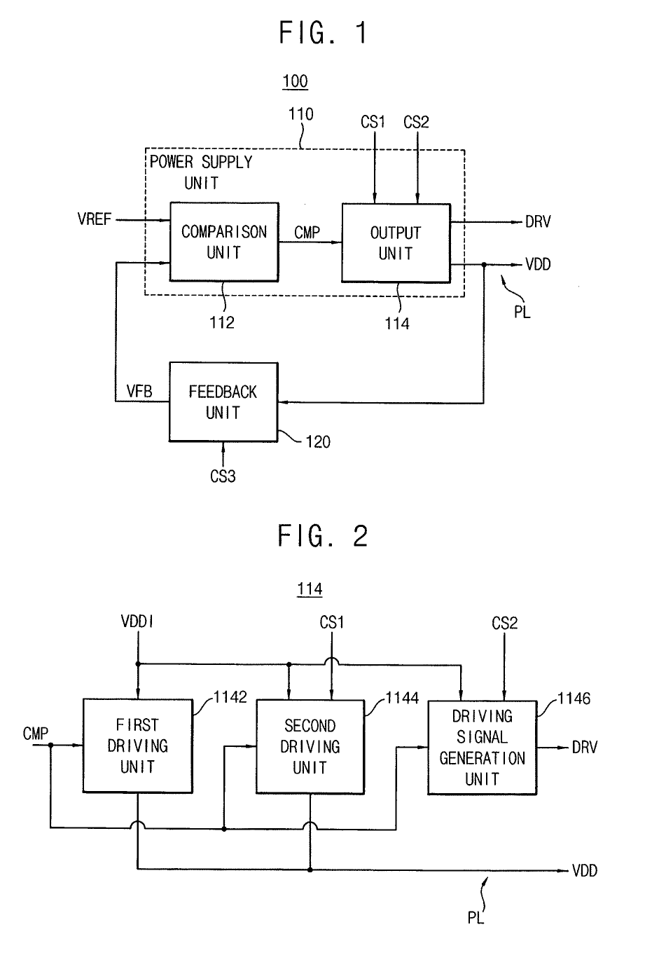

FIG. 2 illustrates a block diagram of an example of an output unit included in the voltage regulator of FIG. 1.

Referring to FIG. 2, the output unit 114 may include a first driving unit 1142, a second driving unit 1144 and a driving signal generation unit 1146. The output unit 114 may receive an unstable input voltage VDDI from an external device, e.g., a voltage generator, and may provide the stable power supply voltage VDD.

The first driving unit 1142 may generate the power supply voltage VDD based on the comparison signal CMP and the input voltage VDDI, and may maintain the level of the power supply voltage VDD. For example, the first driving unit 1142 may maintain the power supply voltage VDD at a constant level by controlling a sourcing current that flows through the first driving unit 1142.

The second driving unit 1144 may increase a current flowing through the power supply line PL based on the comparison signal CMP, the input voltage VDDI and the first control signal CS1. For example, the second driving unit 1144 may provide the first additional current to the power supply line PL based on the comparison signal CMP and the input voltage VDDI, and the current level of the power supply line PL may increase when the first control signal CS1 is activated. The second driving unit 1144 may be disabled when the first control signal CS1 is deactivated.

The driving signal generation unit 1146 may generate the driving signal DRV based on the comparison signal CMP, the input voltage VDDI and the second control signal CS2. For example, the driving signal generation unit 1146 may activate the driving signal DRV based on the comparison signal CMP when the second control signal CS2 is activated. As will be described below with reference to FIG. 6, the driving signal DRV may be provided to the external driver, the external driver may provide the second additional current to the power supply line PL based on the driving signal DRV, and the current level of the power supply line may additionally increase when the second control signal CS2 is activated. The driving signal generation unit 1146 may be disabled when the second control signal CS2 is deactivated.

In an example embodiment, the second control signal CS2 may be activated only after the first control signal CS1 is activated. For example, when the level of the power supply voltage VDD becomes lower than the threshold level, the current level of the power supply line PL may become lower than a predetermined reference current level (e.g., the drivability of the voltage regulator 100 may become lower than a predetermined reference drivability). When the current level of the power supply line PL becomes lower than the reference current level, the first control signal CS1 may be activated, and the first additional current may be provided to the power supply line PL. In addition, when the current level of the power supply line PL is still lower than the reference current level after the first additional current is provided to the power supply line PL, the second control signal CS2 may be activated, and the second additional current may be further provided to the power supply line PL.

In another example embodiment, the second control signal CS2 may be activated regardless of activation of the first control signal CS1. For example, when the current level of the power supply line PL becomes lower than a first reference current level, the first control signal CS1 may be activated, and the first additional current may be provided to the power supply line PL. When the current level of the power supply line PL becomes lower than a second reference current level, the second control signal CS2 may be activated regardless of activation of the first control signal CS1, and the second additional current may be provided to the power supply line PL.

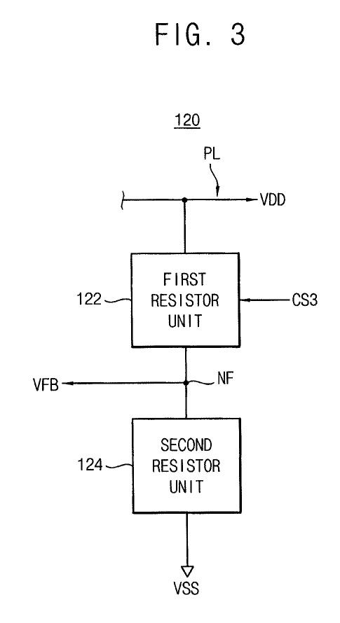

FIG. 3 illustrates a block diagram of an example of a feedback unit included in the voltage regulator of FIG. 1.

Referring to FIG. 3, the feedback unit 120 may include a first resistor unit 122 and a second resistor unit 124.

The first resistor unit 122 may be connected between the power supply line PL and a feedback node NF outputting the feedback voltage VFB. The second resistor unit 124 may be connected between the feedback node NF and a ground voltage VSS.

The feedback unit 120 may divide the power supply voltage VDD, and may provide the feedback voltage VFB to the power supply unit 110. For example, the feedback voltage VFB may be determined depending on a ratio of a resistance of the first resistor unit 122 and a resistance of the second resistor unit 124. The feedback voltage VFB may be determined depending on the target level of the power supply voltage VDD. The relation of the power supply voltage VDD and the feed back voltage VFB may be represented by Equation 1.

$$VDD = VFB \times ( 1 + \frac{{R}_{A}}{{R}_{B}} ) \qquad [ Equation 1 ]$$

In the Equation 1, R_{A} represents the resistance of the first resistor unit 122, and R_{B} represents the resistance of the second resistor unit 124.

In an example embodiment, the resistance of the first resistor unit 122 may be varied based on the third control signal CS3, and thus a resistance of the feedback unit 120 may be varied depending on the varied resistance of the first resistor unit 122. For example, when the level of the power supply voltage VDD is lower than the threshold level, the third control signal CS3 may be activated, and the resistance of the first resistor unit 122 may increase based on the activated third control signal CS3. Thus, the level of the feedback voltage VFB may decrease, and the level of the power supply voltage VDD may increase based on the Equation 1.

FIG. 4 illustrates a diagram of an example of the voltage regulator of FIG. 1.

Referring to FIG. 4, a voltage regulator 100a includes a power supply unit and a feedback unit 120a. The power supply unit may include the comparison unit 112 and the output unit 114.

As described above with reference to FIGS. 1 and 2, the comparison unit 112 may generate the comparison signal CMP based on the reference voltage VREF and the feedback voltage VFB. The output unit 114 may generate the power supply voltage VDD based on the comparison signal CMP, may internally increase the current level of the power supply line PL based on the first control signal CS1, and may generate the driving signal DRV based on the second control signal CS2. The output unit 114 may include the first driving unit 1142, the second driving unit 1144 and the driving signal generation unit 1146.

The first driving unit 1142 may include a first p-type metal oxide semiconductor (PMOS) transistor MP11. The first PMOS transistor MP11 may be connected between the input voltage VDDI and the power supply line PL, and may have a gate electrode receiving the comparison signal CMP.

Although not illustrated in FIG. 4, the first driving unit 1142 may further include an overcurrent protection unit, which may include a resistor and a PMOS transistor. The resistor of the overcurrent protection unit may be connected between the input voltage VDDI and the first PMOS transistor MP11 (e.g., a source electrode of the first PMOS transistor MP11). The PMOS transistor of the overcurrent protection unit may be connected between the input voltage VDDI and the gate electrode of the first PMOS transistor MP11, with a gate electrode connected to the source electrode of the first PMOS transistor MP11. The overcurrent protection unit may prevent a sourcing current IS that flows through the first PMOS transistor MP11 from overly increasing, even though a level of the input voltage VDDI increases.

The second driving unit 1144 may include a second PMOS transistor MP12, a first transmission gate TG11 and a third PMOS transistor MP13. The second PMOS transistor MP12 may be connected between the input voltage VDDI and the power supply line PL, and may have a gate electrode. The first transmission gate TG11 may be connected between the comparison signal CMP and the gate electrode of the second PMOS transistor MP12, and may operate in response to the first control signal CS1. The third PMOS transistor MP13 may be connected between the input voltage VDDI and the gate electrode of the second PMOS transistor MP12, and may have a gate electrode receiving the first control signal CS1.

The driving signal generation unit 1146 may include a second transmission gate TG12 and a fourth PMOS transistor MP14. The second transmission gate TG12 may be connected between the comparison signal CMP and an output terminal of the driving signal DRV, and may operate in response to the second control signal CS2. The fourth PMOS transistor MP14 may be connected between the input voltage VDDI and the output terminal of the driving signal DRV, and may have a gate electrode receiving the second control signal CS2.

As described above with reference to FIGS. 1 and 3, the feedback unit 120a generates the feedback voltage VFB based on the power supply voltage VDD, and controls the level of the feedback voltage VFB based on the third control signal CS3. The feedback unit 120a may include a first resistor unit 122a and a second resistor unit 124.

The first resistor unit 122a may include a first resistor R11, a second resistor R12 and a third transmission gate TG13. The first resistor R11 may be connected to the feedback node NF outputting the feedback voltage VFB. The second resistor R12 may be connected between the first resistor R11 and the power supply line PL. The third transmission gate TG13 may be connected in parallel with the second resistor R12 between the first resistor R11 and the power supply line PL, and may operate in response to the third control signal CS3. The second resistor unit 124 may include a third resistor R13 that is connected between the feedback node NF and the ground voltage VSS.

Hereinafter, an operation of the voltage regulator 100a according to some example embodiments will be explained in detail with reference to FIG. 4.

In an example embodiment, the comparison unit 112 detects the difference between the reference voltage VREF and the feedback voltage VFB to generate the comparison signal CMP including information about variation of the power supply voltage VDD. The first PMOS transistor MP11 maintains the power supply voltage VDD at the constant level by controlling the sourcing current IS that flows through the first PMOS transistor MP11. For example, the sourcing current IS may increase if the power supply voltage VDD decreases, and the sourcing current IS may decrease if the power supply voltage VDD increases. The feedback unit 120a divides the power supply voltage VDD based on the ratio of the resistance of the first resistor unit 122a and the resistance of the second resistor unit 124, and provides the feedback voltage VFB to the comparison unit 112.

When the power supply voltage VDD is maintained at the constant level, in other words, when the level of the power supply voltage VDD is higher than the threshold level and the drivability of the voltage regulator 100a is higher than the reference drivability, the first control signal CS1, the second control signal CS2 and the third control signal CS3 are deactivated, respectively. For example, the first control signal CS1 has a logic low level, the first transmission gate TG11 is turned off, the third PMOS transistor MP13 is turned on, and thus the second PMOS transistor MP12 is turned off. The second driving unit 1144 is disabled. The second control signal CS2 has the logic low level, the second transmission gate TG12 is turned off, the fourth PMOS transistor MP14 is turned on, and thus the driving signal DRV is deactivated (e.g., has a logic high level). The driving signal generation unit 1146 and the external driver (not illustrated) receiving the driving signal DRV are disabled. The third control signal CS3 has the logic low level, the third transmission gate TG13 is turned on, and thus the resistance of the first resistor unit 122a may be determined based on the first resistor R11.

When the level of the power supply voltage VDD is lower than the threshold level, at least one of the first control signal CS1, the second control signal CS2 and the third control signal CS3 is activated. For example, when the level of the power supply voltage VDD is lower than the threshold level and the integrated circuit including the voltage regulator 100a complies with a first operation criterion, the first control signal CS1 is activated. The first control signal CS1 is transitioned from the logic low level to the logic high level, the first transmission gate TG11 is turned on, the third PMOS transistor MP13 is turned off, and thus the gate electrode of the second PMOS transistor MP12 receives the comparison signal CMP. The second PMOS transistor MP12 generates a first additional current I1 in response to the comparison signal CMP and the input signal VDDI, and provides the first additional current I1 to the power supply line PL, thereby increasing the current flowing through the power supply line PL.

When the level of the power supply voltage VDD is lower than the threshold level and the integrated circuit including the voltage regulator 100a complies with a second operation criterion, the second control signal CS2 is activated. The second control signal CS2 is transitioned from the logic low level to the logic high level, the second transmission gate TG12 is turned on, the fourth PMOS transistor MP14 is turned off, and thus the driving signal generation unit 1146 may output the comparison signal CMP as the driving signal DRV. The external driver generates a second additional current in response to the driving signal DRV (i.e., the comparison signal CMP), and provides the second additional current to the power supply line PL, thereby additionally increasing the current flowing through the power supply line PL.

When the level of the power supply voltage VDD is lower than the threshold level and the integrated circuit including the voltage regulator 100a complies with a third operation criterion, the third control signal CS3 is activated. The third control signal CS2 is transitioned from the logic low level to the logic high level, the third transmission gate TG13 is turned on, and thus the resistance of the first resistor unit 122a may be determined based on the first resistor R11 and the second resistor R12. The resistance of the first resistor unit 122a increases because the first resistor R11 and the second resistor R12 are connected in series. Thus, the level of feedback voltage VFB decreases, and the level of the power supply voltage VDD increases.

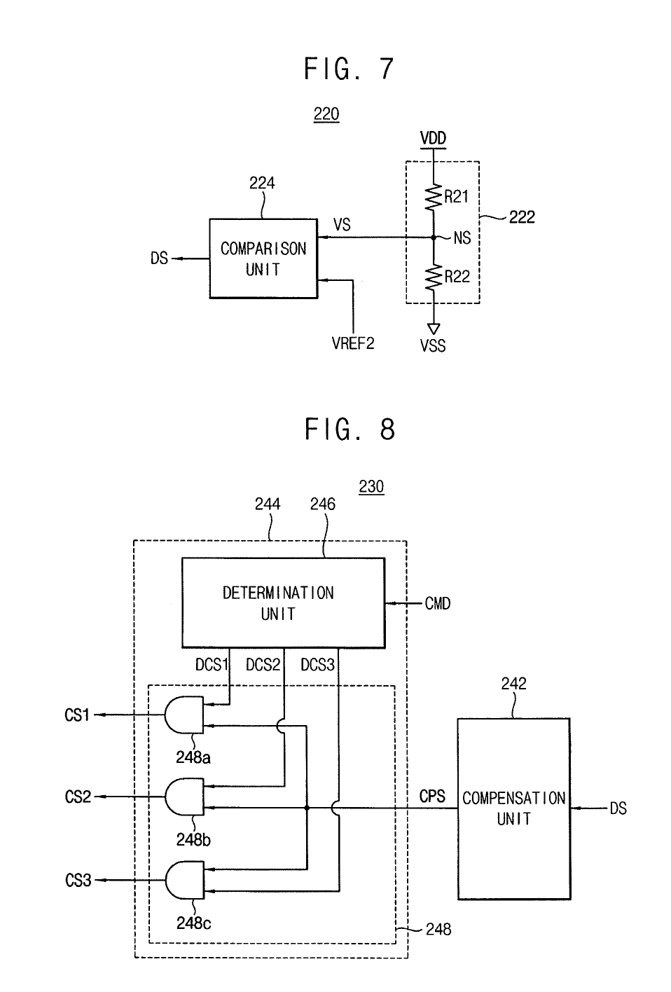

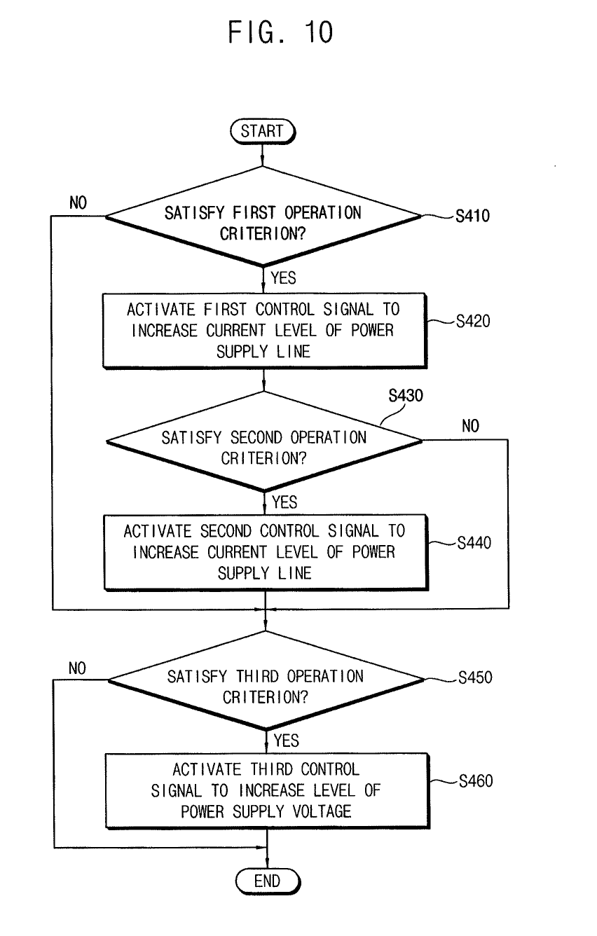

Example embodiments with respect to the first operation criterion, the second operation criterion and the third operation criterion will be described below with reference to FIGS. 8 and 10.

FIG. 5 illustrates a diagram of another example of the voltage regulator of FIG. 1.

Referring to FIG. 5, a voltage regulator 100b includes a power supply unit and a feedback unit 120b. The power supply unit may include the comparison unit 112 and the output unit 114.

In comparison with the voltage regulator 100a of FIG. 4, the voltage regulator 100b may include the feedback unit 120b instead of the feedback unit 120a. The comparison unit 112 and the output unit 114 in FIG. 5 may be substantially the same as the comparison unit 112 and the output unit 114 in the FIG. 4, respectively.

The feedback unit 120b may include a first resistor unit 122b and the second resistor unit 124. The first resistor unit 122b may include a variable resistor RV. The variable resistor RV may be connected between the feedback node NF and the power supply line PL, and a resistance of the variable resistor RV may be varied based on the third control signal CS3. For example, the variable resistor RV may have a first resistance when the third control signal CS3 is deactivated, and may have a second resistance that is larger than the first resistance when the third control signal CS3 is activated. The second resistor unit 124 may include the resistor R13 that is connected between the feedback node NF and the ground voltage VSS. The feedback unit 120b may divide the power supply voltage VDD based on a ratio of the resistance of the variable resistor RV and a resistance of the resistor R13, and may provide the feedback voltage VFB to the comparison unit 112.

FIG. 6 illustrates a block diagram of an integrated circuit according to some example embodiments.

Referring to FIG. 6, an integrated circuit 200 includes a voltage regulator 210, a voltage detector 220, a regulator controller 230 and a driver 240. Although not illustrated in FIG. 6, the integrated circuit 200 may further include at least one of various logic circuits performing particular functions.

The voltage regulator 210 may be the voltage regulator 100 of FIG. 1. The voltage regulator 210 generates the power supply voltage VDD based on a first reference voltage VREF1 and the feedback voltage VFB, controls a current level of the power supply line PL based on the first control signal CS1, generates the driving signal DRV based on the second control signal CS2, and controls a level of the feedback voltage VFB based on the third control signal CS3. The power supply voltage VDD is provided to the logic circuits included in the integrated circuit 200 through the power supply line PL. The voltage regulator 210 may include a power supply unit 212 and a feedback unit 214.

The voltage detector 220 generates a detection signal DS based on the power supply voltage VDD and a second reference voltage VREF2. The detection signal DS indicates whether a level of the power supply voltage VDD is lower than a threshold level. For example, the detection signal DS may be deactivated (e.g., may have a logic low level) when the level of the power supply voltage VDD is higher than the threshold level, and may be activated (e.g., may have a logic high level) when the level of the power supply voltage VDD is lower than the threshold level.

The regulator controller 230 generates the first control signal CS1, the second control signal CS2 and the third control signal CS3 based on the detection signal DS. For example, at least one of the first control signal CS1, the second control signal CS2 and the third control signal CS3 may be activated when the level of the power supply voltage is lower than the threshold level. The power supply unit 212 may provide a first additional current to the power supply line PL based on the activated first control signal CS1, and may activate the driving signal DRV based on the activated second control signal CS2. The feedback unit 214 may decrease the level of the feedback voltage VFB based on the activated third control signal CS3, and the power supply unit 212 may increase the level of the power supply voltage VDD based on the decreased feedback voltage VFB.

The driver 240 additionally controls the current level of the power supply line PL based on the driving signal DRV. For example, the driver 240 may provide a second additional current I2 to the power supply line PL based on the driving signal DRV and an input voltage VDDI, and the current level of the power supply line PL may additionally increase when the second control signal CS2 is activated. The driver 240 may be disabled when the second control signal CS2 is deactivated. The driver 240 may include a PMOS transistor MP21. The PMOS transistor MP21 may be connected between the input voltage VDDI and the power supply line PL, and may have a gate electrode receiving the driving signal DRV.

In an example embodiment, to reduce an effect of noises on a driving signal supply line DL, the driving signal supply line DL may be shielded by a shielding material. The driving signal DRV may be provided to the driver 240 through the driving signal supply line DL. For example, the driving signal supply line DL may be shielded by a shielding layer connected to a ground voltage.

In an example embodiment, the voltage detector 220 and the driver 240 may be connected to an end of the power supply line PL. In other words, the voltage detector 220 and the driver 240 may be disposed farthest from the voltage regulator 210 in the integrated circuit 200. Generally, a voltage drop, that is, IR-drop on the power supply line PL, may be serious at the end of the power supply line PL due to logic circuits (not illustrated) that are connected to a middle of the power supply line PL and consume power (e.g., the power supply voltage VDD). Thus, the voltage regulator 210 may effectively supply stable power (e.g., the power supply voltage VDD) to the logic circuits by detecting the voltage drop on the end of the power supply line PL and by providing the second additional current I2 to the end of the power supply line PL based on the detecting result.

Although not illustrated in FIG. 6, the integrated circuit 200 may further include a reference voltage generator that generates the reference voltages VREF1 and VREF2, and a terminal resistor (not illustrated) that is connected to the end of the power supply line PL.

In the integrated circuit 200 according to some example embodiments, the voltage regulator 210 may provide the first additional current to the power supply line PL based on the first control signal CS1, and may increase the level of the power supply voltage VDD based on the third control signal CS3 and the feedback voltage VFB. The driver 240 may provide the second additional current I2 to the power supply line PL based on the second control signal CS2 and the driving signal DRV. In addition, the voltage detector 220 and the regulator controller 230 may generate the control signals CS1, CS2 and CS3 that are used to control the current level of the power supply line PL and/or the level of the power supply voltage VDD. Thus, the voltage drop on the power supply line PL may be effectively compensated, and stable power may be effectively provided to the logic circuits.

FIG. 7 illustrates a block diagram of an example of a voltage detector included in the integrated circuit of FIG. 6.

Referring to FIG. 7, the voltage detector 220 may include a voltage dividing unit 222 and a comparison unit 224.

The voltage dividing unit 222 may generate a sensing voltage VS by dividing the power supply voltage VDD by a predetermined ratio. The voltage dividing unit 222 may include a first division resistor R21 and a second division resistor R22. The first division resistor R21 may be connected between the power supply voltage VDD (e.g., the end of the power supply line PL) and a sensing node NS. The second division resistor R22 may be connected between the sensing node NS and a ground voltage VSS.

The comparison unit 224 may generate the detection signal DS by comparing the sensing voltage VS with the second reference voltage VREF2. The second reference voltage VREF2 may be set such that the power supply voltage VDD corresponds to the threshold level. For example, the detection signal DS may have the logic low level when a level of the sensing voltage VS (e.g., the level of the power supply voltage) is higher than a level of the second reference voltage VREF2 (e.g., the threshold level), and may have the logic high level when the level of the sensing voltage VS is lower than the level of the second reference voltage VREF2.

In an example embodiment, the threshold level may be higher than a minimum voltage level that is required to normally operate the integrated circuit 200 of FIG. 6. For example, the integrated circuit 200 and the logic circuits (not illustrated) may normally operate based on the power supply voltage VDD having a level of about 1.35V to about 1.65V (i.e., about 1.5V±10%). In other words, the minimum voltage level may be set to about 1.35V. In this case, the threshold level may be set to about 1.4V, which is higher than the minimum voltage level. If the threshold level is set to a level being substantially the same as the minimum voltage level, the power supply voltage VDD may become lower than the minimum voltage level, and the logic circuits and the integrated circuit may malfunction because a time for compensating the voltage drop on the power supply line PL is required after the power supply voltage VDD decreases to the threshold level (i.e., the minimum voltage level). In the integrated circuit 200 according to some example embodiments, the voltage drop on the power supply line PL may be effectively compensated by setting the threshold level to be higher than the minimum voltage level.

In an example embodiment, the level of the second reference voltage VREF2 may be determined depending on the threshold level and a ratio of resistances of the division resistors R21 and R22. For example, if the threshold level corresponds to about 1.4V and the ratio of the resistances of the division resistors R21 and R22 corresponds to about 1:1, the level of the second reference voltage VREF2 may correspond to about 0.7V. In this case, when the level of the sensing voltage VS is higher than about 0.7V, the comparison unit 224 may determine that the voltage drop has not occurred, and may output the detection signal DS having the logic low level. When the level of the sensing voltage VS is lower than about 0.7V, the comparison unit 224 may determine that the voltage drop has occurred, and may output the detection signal DS having the logic high level.

Although not illustrated in FIG. 7, the voltage detector may be implemented without the voltage dividing unit 222. In that case, the power supply voltage VDD may be directly applied to the comparison unit 224, and the level of the second reference voltage VREF2 may correspond to the threshold level (e.g., about 1.4V).

FIG. 8 illustrates a block diagram of an example of a regulator controller included in the integrated circuit of FIG. 6.

Referring to FIG. 8, the regulator controller 230 may include a compensation unit 242 and a control signal generation unit 244.

The compensation unit 242 may generate a compensation signal CPS by reducing noise in the detection signal DS. The compensation unit 242 may include a filter. The filter may periodically sample the detection signal DS, and may generate the compensation signal CPS based on the sampled detection signal. The compensation signal CPS may correspond to, e.g., an average value or a median value of the sampled detection signal. In other words, the filter may be an average filter or a median filter. The number of times of filtering for the detection signal DS may be fixed or variable.

In the case that the filter is the median filter, the filter may sample the detection signal DS five times, and output a median value of the sampling result (e.g., the five sampling values) as the compensation signal CPS. If the sampling result corresponds to “LHLLL” or “HLLLL”, the filter may determine that “H (i.e., the logic high level)” included in the sampling result is a noise, and thus the filter may output the compensation signal CPS having “L (i.e., the logic low level)”. If the sampling result corresponds to “HHHLL” or “HHHHL”, that is, if the “H” is continuously sampled, the filter may determine that the detection signal DS is transitioned from the “L” to the “H”, and thus the filter may output the compensation signal CPS having the “H”.

The control signal generation unit 244 may generate the first control signal CS1, the second control signal CS2 and the third control signal CS3 based on the compensation signal CPS and a command signal CMD. The control signal generation unit 244 may receive the command signal CMD from an external device such as a main controller. The command signal CMD may indicate whether the logic circuits (not illustrated) in the integrated circuit 200 of FIG. 6 are enabled, or whether the integrated circuit 200 of FIG. 6 performs the predetermined functions. The control signal generation unit 244 may include a determination unit 246 and a logic operation unit 248.

The determination unit 246 may generate a first driving control signal DCS1, a second driving control signal DCS2 and a third first driving control signal DCS3 based on the command signal CMD. Each of the first, second and third driving control signals DCS1, DCS2 and DCS3 may indicate whether controlling the current level of the power supply line PL is necessary and/or whether controlling the level of the power supply voltage VDD is necessary. For example, the first and second driving control signals DCS1 and DCS2 may indicate whether controlling the current level of the power supply line PL is desired, and the third driving control signal DCS3 may indicate whether controlling the level of the power supply voltage VDD is desired.

The first driving control signal DCS1 may be activated when the integrated circuit 200 of FIG. 6 complies with the first operation criterion. Assuming that the integrated circuit 200 of FIG. 6 includes N logic circuits, where N is a natural number equal to or greater than two, the first operation criterion may be satisfied when at least X number of logic circuits of the N logic circuits are enabled, where X is a natural number equal to or greater than one and equal to or less than N. Assuming that the integrated circuit 200 of FIG. 6 performs N predetermined functions, the N predetermined functions may include a function with relatively high power consumption, e.g., a pentile function, a contents-based automatic brightness control (CABC) function used in a mobile display device, etc. In this case, the first operation criterion may be satisfied when at least X number of functions of the N predetermined functions are performed. In another implementation, the first operation criterion may be satisfied when the current level of the power supply line PL is smaller than a first reference current level.

The second driving control signal DCS2 may be activated when the integrated circuit 200 of FIG. 6 complies with the second operation criterion. In an example embodiment, the second control signal CS2 may be activated only after the first control signal CS1 is activated. The second driving control signal DCS2 may also be activated only after the first driving control signal DCS1 is activated. If the integrated circuit 200 of FIG. 6 includes N logic circuits, the second operation criterion may be satisfied when at least Y number of logic circuits of the N logic circuits are enabled, where Y is a natural number equal to or greater than (X+1) and equal to or less than N. If the integrated circuit 200 of FIG. 6 performs N predetermined functions, the second operation criterion may be satisfied when at least Y number of functions of the N predetermined functions are performed. In another implementation, the second operation criterion may be satisfied when the current level of the power supply line PL is still smaller than the first reference current level after the first control signal CS1 is activated.

In another example embodiment, the second control signal CS2 may be activated regardless of activation of the first control signal CS1. The second driving control signal DCS2 may also be activated regardless of activation of the first driving control signal DCS1. The second operation criterion may be satisfied when at least Y′ of logic circuits of the N logic circuits are enabled, or when at least Y′ number of functions of the N predetermined functions are performed, where Y′ is a natural number equal to or greater than one and equal to or less than N. In another implementation, the second operation criterion may be satisfied when the current level of the power supply line PL is smaller than a second reference current level.

The third driving control signal DCS3 may be activated when the integrated circuit 200 of FIG. 6 complies with the third operation criterion. If the integrated circuit 200 of FIG. 6 includes N logic circuits, the third operation criterion may be satisfied when at least Z number of logic circuits of the N logic circuits are enabled, where Z is a natural number equal to or greater than one and equal to or less than N. If the integrated circuit 200 of FIG. 6 performs N predetermined functions, the third operation criterion may be satisfied when at least Z number of functions of the N predetermined functions are performed. In another implementation, the third operation criterion may be satisfied when the level of the power supply voltage VDD is smaller than a predetermined voltage level (e.g., the minimum voltage level).

The logic operation unit 248 may generate the first control signal CS1, the second control signal CS2 and the third control signal CS3 by performing a logic operation on the compensation signal CPS, the first driving control signal DCS1, the second driving control signal DCS2 and the third driving control signal DCS3. For example, the first control signal CS1 may be activated when both of the compensation signal CPS and the first driving control signal DCS1 are activated, the second control signal CS2 may be activated when both of the compensation signal CPS and the second driving control signal DCS2 are activated, and the third control signal CS3 may be activated when both of the compensation signal CPS and the third driving control signal DCS3 are activated.

The logic operation unit 248 may include a first AND gate 248a, a second AND gate 248b and a third AND gate 248c. The first AND gate 248a may perform an AND operation on the first driving control signal DCS1 and the compensation signal CPS to generate the first control signal CS1. The second AND gate 248b may perform the AND operation on the second driving control signal DCS2 and the compensation signal CPS to generate the second control signal CS2. The third AND gate 248c may perform the AND operation on the third driving control signal DCS3 and the compensation signal CPS to generate the third control signal CS3. Although the logic operation unit 248 including three AND gates is illustrated in FIG. 8, the number and/or the type of the logic gates included in the logic operation unit is not limited thereto.

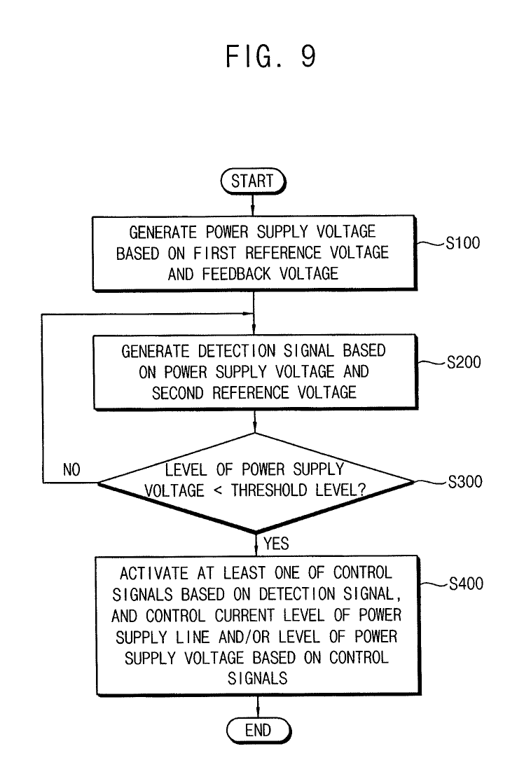

FIG. 9 illustrates a flow chart of an example of a method of operating the integrated circuit of FIG. 6. FIG. 9 illustrates an operation of providing the power supply voltage VDD and compensating the voltage drop on the power supply line PL.

Referring to FIGS. 6 and 9, in an example embodiment the voltage regulator 210 generates the power supply voltage VDD based on the first reference voltage VREF1 and the feedback voltage VFB (operation S100). The power supply voltage VDD may be provided to the entire integrated circuit 200 including the logic circuits (not illustrated) through the power supply line PL.

The voltage detector 220 generates the detection signal DS based on the power supply voltage VDD and the second reference voltage VREF2 (operation S200). The logic level of the detection signal DS is checked to determine whether the level of the power supply voltage VDD is lower than the threshold level (operation S300). As described above with reference to FIG. 7, the second reference voltage VREF2 may correspond to the threshold level, and the threshold level may be higher than the minimum voltage level that is required to normally operate the integrated circuit 200. The detection signal DS may have the logic low level when the level of the power supply voltage VDD is higher than the threshold level, and may have the logic high level when the level of the power supply voltage VDD is lower than the threshold level.

If the level of the power supply voltage VDD is higher than the threshold level, the control signals CS1, CS2 and CS3 are maintained at deactivation states (e.g., the logic low levels), and the operations 5200 and 5300 are repeated.

If the level of the power supply voltage VDD is lower than the threshold level, the regulator controller 230 activates at least one of the first, second and third control signal CS1, CS2 and CS3 based on the detection signal DS, and the voltage regulator 210 and/or the driver 240 controls the current level of the power supply line PL and/or the level of the power supply voltage VDD (operation S400).

FIG. 10 illustrates a flow chart of an example of operation S400 in FIG. 9.

Referring to FIGS. 6, 9 and 10, in the operation 5400, the regulator controller 230 may determine whether the integrated circuit 200 complies with the first operation criterion based on the command signal CMD (operation S410). As described above with reference to FIG. 8, the first operation criterion may be satisfied when at least X of logic circuits are enabled, when at least X of functions are performed or when the current level of the power supply line PL is smaller than the first reference current level.

If the first operation criterion is not satisfied, the regulator controller 230 may perform operation S450 without performing operation 5430. In other words, the regulator controller 230 may determine whether the integrated circuit 200 complies with the second operation criterion only when the integrated circuit 200 complies with the first operation criterion, and the second control signal CS2 may be activated only after the first control signal CS1 is activated.

If the first operation criterion is satisfied, the regulator controller 230 may activate the first control signal CS1 and the voltage regulator 210 may increase the current level of the power supply line PL based on the first control signal CS1 (operation S420). As described above with reference to FIG. 4, the second PMOS transistor MP12 in the voltage regulator 210 may provide the first additional current I1 to the power supply line PL based on the first control signal CS1, thereby increasing the current flowing through the power supply line PL.

The regulator controller 230 may determine whether the integrated circuit 200 complies with the second operation criterion based on the command signal CMD (operation S430). As described above with reference to FIG. 8, the second operation criterion may be satisfied when at least Y number of logic circuits are enabled, when at least Y of functions are performed or when the current level of the power supply line PL is still smaller than the first reference current level after the first control signal CS1 is activated. The natural number Y may be greater than the natural number X.

If the second operation criterion is not satisfied, the regulator controller 230 may perform the operation 5450.

If the second operation criterion is satisfied, the regulator controller 230 may activate the second control signal CS2, the voltage regulator 210 may activate the driving signal DRV based on the second control signal CS2, and the driver 240 may increase the current level of the power supply line PL based on the driving signal DRV (operation S440). The PMOS transistor MP21 in the driver 240 may provide the second additional current I2 to the power supply line PL based on the second control signal CS2, thereby additionally increasing the current flowing through the power supply line PL.

The regulator controller 230 may determine whether the integrated circuit 200 complies with the third operation criterion based on the command signal CMD (operation S450). As described above with reference to FIG. 8, the third operation criterion may be satisfied when at least Z number of logic circuits are enabled, when at least Z of functions are performed or when the level of the power supply voltage VDD is smaller than the predetermined voltage level.

If the third operation criterion is not satisfied, the operation of controlling the current level of the power supply line PL and/or the level of the power supply voltage VDD may be finished.

If the third operation criterion is satisfied, the regulator controller 230 may activate the third control signal CS3, and the voltage regulator 210 may increase the level of the power supply voltage VDD based on the third control signal CS3 (operation S460). As described above with reference to FIG. 4, the resistance of the first resistor unit 122a in the voltage regulator 210 may increase based on the third control signal CS3, the level of the feedback voltage VFB may decrease, and thus the level of the power supply voltage VDD may increase.

Although not illustrated in FIG. 10, the regulator controller 230 may determine whether the integrated circuit 200 complies with the second operation criterion regardless of satisfaction of the first operation criterion. In other words, if the first operation criterion is not satisfied, the regulator controller 230 may perform the operation S430. The second control signal CS2 may be activated regardless of activation of the first control signal CS1.

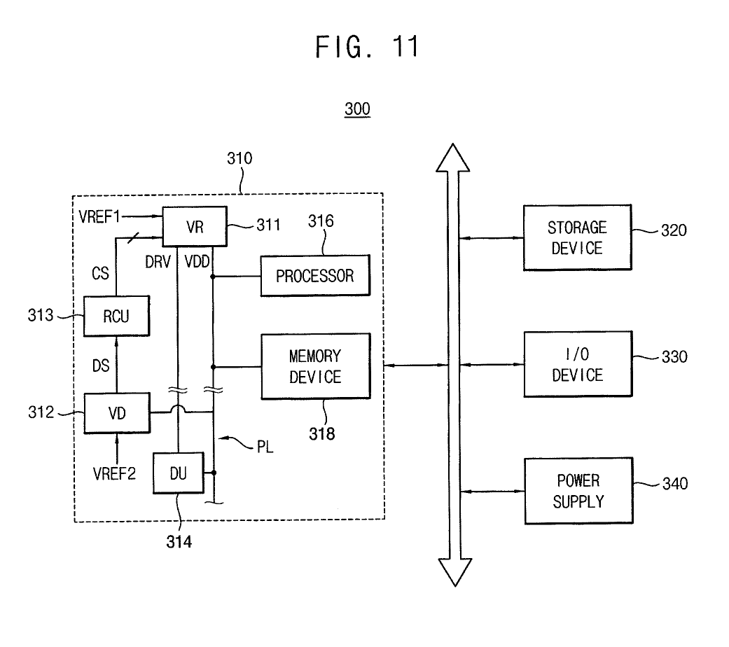

FIG. 11 illustrates a block diagram of an electronic system including an integrated circuit according to an example embodiment.

Referring to FIG. 11, the electronic system 300 may include an integrated circuit 310, a storage device 320, an input/output (I/O) device 330, and a power supply 340. Although not illustrated in FIG. 11, the electronic system 300 may further include a plurality of ports for communicating a video card, a sound card, a memory card, a universal serial bus (USB) device, other electric devices, etc. The electronic system 300 may further include a baseband chipset, an application chipset, an image sensor, etc.

The integrated circuit 310 may be the integrated circuit 200 of FIG. 6. The integrated circuit 310 may include a voltage regulator 311, a voltage detector 312, a regulator controller 313 and a driver 314. The voltage regulator 311 may be the voltage regulator 100 of FIG. 1. The voltage regulator 311 may generate a power supply voltage VDD based on a first reference voltage VREF1 and a feedback voltage VFB. The voltage regulator 311 may control a current level of a power supply line PL, may generate a driving signal DRV, and may control a level of the feedback voltage VFB based on control signals CS. The power supply voltage VDD is provided to a processor 316, a memory device 318 and/or other logic circuits (not illustrated) included in the integrated circuit 310 through the power supply line PL. The voltage detector 312 may generate a detection signal DS based on the power supply voltage VDD and a second reference voltage VREF2. The regulator controller 313 may generate the control signals CS based on the detection signal DS. The driver 314 may additionally control the current level of the power supply line PL based on the driving signal DRV. In the integrated circuit 310, the voltage regulator 311 may provide the first additional current to the power supply line and may increase the level of the power supply voltage VDD, and the driver 314 may provide the second additional current to the power supply line PL. Thus, the voltage drop on the power supply line PL may be effectively compensated, and stable power may be effectively provided to the processor 316, the memory device 318 and/or the logic circuits.

In an example embodiment, the integrated circuit 310 including the voltage regulator 311, the voltage detector 312, the regulator controller 313, the driver 314, the processor 316, the memory device 318 and/or other logic circuits (not illustrated) may be fabricated as one integrated circuit chip, e.g., a system-on-chip (SoC).

The processor 316 may perform various computing functions. The processor 316 may be a micro processor, a central processing unit (CPU), and etc. The processor 316 may be connected to the memory device 318, the storage device 320, and the I/O device 330 via a bus such as an address bus, a control bus, a data bus, etc. The processor 316 may be connected to an extended bus such as a peripheral component interconnection (PCI) bus.

In an example embodiment, the processor 316 may be implemented with a single-core processor or a multi-core processor, such as a dual-core processor, a quad-core processor, a hexa-core processor, etc. For example, assuming that the processor 316 is an ARM processor, the processor 316 may be implemented with the single-core processor when the processor 316 operates with relatively low speed (e.g., lower than about 1 GHz), and may be implemented with the multi-core processor when the processor 316 operates with relatively high speed (e.g., higher than about 1 GHz). For example, the multi-core ARM processor may be connected to the peripheral devices (e.g., the memory device 318, the storage device 320, and the I/O device 330) via an advanced extensible interface (AXI) bus.

The memory device 318 may store data for operations of the electronic system 300. For example, the memory device 318 may include a dynamic random access memory (DRAM) device, a static random access memory (SRAM) device, an erasable programmable read-only memory (EPROM) device, an electrically erasable programming read-only memory (EEPROM) device, a flash memory device, etc.

The storage device 320 may include a solid state drive device, a hard disk drive device, a CD-ROM device, etc. The I/O device 330 may include input devices such as a keyboard, a keypad, a mouse, etc, and output devices such as a printer, a display device, etc. The power supply 340 may provide a power for operations of the electronic system 300.

The above described embodiments may be applied to an integrated circuit, and an electronic system having the integrated circuit. For example, the electronic system may be a system using an image sensor such as a computer, a digital camera, a 3-D camera, a cellular phone, a personal digital assistant (PDA), a scanner, a navigation system, a video phone, a surveillance system, an auto-focusing system, a tracking system, a motion-sensing system, an image-stabilization system, etc.

By way of summation and review, example embodiments provide a voltage regulator capable of effectively supplying stable power to a logic circuit. Example embodiments also provide an integrated circuit including the voltage regulator. In a voltage regulator according to some example embodiments a first additional current may be provided to a power supply line based on a first control signal, a driving signal may be generated based on the second control signal, and levels of the feedback voltage and the power supply voltage may be controlled based on a third control signal. The external driver may provide a second additional current to the power supply line based on the driving signal. Thus, a current flowing through the power supply line may increase (while avoiding increases in a width of a power supply line), a level of the power supply voltage may be increased, and the voltage regulator may effectively supply stable power to logic circuits included in the integrated circuit. Thus, in an integrated circuit including the voltage regulator, a voltage drop on the power supply line may be effectively compensated.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A voltage regulator, comprising:
a power supply unit configured to generate a power supply voltage based on a reference voltage and a feedback voltage, configured to control a current level of a power supply line based on a first control signal, and configured to generate a driving signal based on a second control signal, the power supply voltage being provided to an external logic circuit through the power supply line, and the current level of the power supply line being additionally controlled outside the power supply unit based on the driving signal; and
a feedback unit configured to generate the feedback voltage based on the power supply voltage, and configured to control a level of the feedback voltage based on a third control signal.

2. The voltage regulator as claimed in claim 1, wherein at least one of the first control signal, the second control signal and the third control signal is activated when a level of the power supply voltage is lower than a threshold level.

3. The voltage regulator as claimed in claim 2, wherein the power supply unit increases the current level of the power supply line when the first control signal is activated.

4. The voltage regulator as claimed in claim 3, wherein the power supply unit activates the driving signal such that an external driver additionally increases the current level of the power supply line based on the activated driving signal when the second control signal is activated.

5. The voltage regulator as claimed in claim 2, wherein the feedback unit decreases the level of the feedback voltage by varying a resistance of the feedback unit when the third control signal is activated.

6. The voltage regulator as claimed in claim 1, wherein the power supply unit includes:
a comparison unit configured to generate a comparison signal based on the reference voltage and the feedback voltage; and
an output unit configured to generate the power supply voltage based on the comparison signal, configured to internally increase the current level of the power supply line based on the first control signal, and configured to generate the driving signal based on the second control signal.

7. The voltage regulator as claimed in claim 6, wherein the output unit includes:
a first driving unit configured to generate the power supply voltage based on the comparison signal and an input voltage;
a second driving unit configured to provide an additional current to the power supply line based on the comparison signal and the input voltage when the first control signal is activated; and
a driving signal generation unit configured to activate the driving signal based on the comparison signal when the second control signal is activated.

8. The voltage regulator as claimed in claim 7, wherein the second driving unit includes:
a first p-type metal oxide semiconductor (PMOS) transistor connected between the input voltage and the power supply line, and having a gate electrode;
a first transmission gate configured to receive the comparison signal and connected to the gate electrode of the first PMOS transistor, and operating in response to the first control signal; and
a second PMOS transistor connected between the input voltage and the gate electrode of the first PMOS transistor, and having a gate electrode receiving the first control signal.

9. The voltage regulator as claimed in claim 8, wherein the driving signal generation unit includes:
a second transmission gate configured to receive the comparison signal and connected to an output terminal of the driving signal, and operating in response to the second control signal; and
a third PMOS transistor connected between the input voltage and the output terminal of the driving signal, and having a gate electrode receiving the second control signal.

10. The voltage regulator as claimed in claim 1, wherein the feedback unit includes:
a first resistor unit connected between the power supply line and a feedback node outputting the feedback voltage, a resistance of the first resistor unit being varied based on the third control signal; and
a second resistor unit connected between the feedback node and a ground voltage.

11. The voltage regulator as claimed in claim 10, wherein the first resistor unit includes:
a first resistor connected to the feedback node;
a second resistor connected between the first resistor and the power supply line; and
a transmission gate connected in parallel with the second resistor between the first resistor and the power supply line, and operating in response to the third control signal.

12. An integrated circuit, comprising:
a voltage regulator configured to generate a power supply voltage based on a first reference voltage and a feedback voltage, configured to control a current level of a power supply line based on a first control signal, configured to generate a driving signal based on a second control signal, and configured to control a level of the feedback voltage based on a third control signal, the power supply voltage being provided to a logic circuit included in the integrated circuit through the power supply line;
a voltage detector configured to generate a detection signal based on the power supply voltage and a second reference voltage, the detection signal indicating whether a level of the power supply voltage is lower than a threshold level;
a regulator controller configured to generate the first control signal, the second control signal and the third control signal based on the detection signal; and
a driver configured to additionally control the current level of the power supply line based on the driving signal.

13. The integrated circuit as claimed in claim 12, wherein the regulator controller includes:
a compensation unit configured to generate a compensation signal by reducing noise in the detection signal; and
a control signal generation unit configured to generate the first control signal, the second control signal and the third control signal based on the compensation signal and a command signal.

14. The integrated circuit as claimed in claim 13, wherein the compensation unit includes:
a filter configured to periodically sample the detection signal, and configured to generate the compensation signal based on the sampled detection signal, the compensation signal corresponding to an average value or a median value of the sampled detection signal.

15. The integrated circuit as claimed in claim 13, wherein the control signal generation unit includes:
a determination unit configured to generate a first driving control signal, a second driving control signal and a third driving control signal based on the command signal and each of the first, second and third driving control signals indicating whether controlling the current level of the power supply line is to be performed and/or whether controlling the level of the power supply voltage is to be performed; and
a logic operation unit configured to generate the first control signal, the second control signal and the third control signal by performing a logic operation on the compensation signal, the first driving control signal, the second driving control signal and the third driving control signal.

16. An integrated circuit, comprising:
a supply unit configured to receive a feedback voltage and a first reference voltage, and configured to generate a driving signal and a power supply voltage based on the first reference voltage and the feedback voltage, the power supply voltage being supplied to a power supply line, the driving signal being supplied to a driving signal line, and the feedback voltage being received on a feedback voltage line and being based on a voltage of the power supply line;
a detector unit configured to sense a voltage on the power supply line at a location on the power supply line that is external to the supply unit, and configured to generate a detection signal based on the sensed voltage and a second reference voltage;
a controller unit configured to receive the detection signal and, based on the detection signal, control at least one of a voltage on the feedback voltage line, a voltage on the driving signal line, and a voltage on the power supply line;
logic circuits, the logic circuits being external to the supply unit, the power supply voltage being supplied from the supply unit to the logic circuits on the power supply line; and
a driver unit, the driver unit being located apart from the supply unit and supplying a current on the power supply line at a location between the logic circuits and the supply unit, the current supplied by the driver unit to the power supply line being controlled by the voltage on the driving signal line.

17. The integrated circuit as claimed in claim 16, wherein the controller unit controls the voltage on the feedback voltage line, the voltage on the feedback voltage line being controlled by controlling operation of a voltage divider on the feedback voltage line.

18. The integrated circuit as claimed in claim 16, wherein the controller unit controls the voltage on the driving signal line.

19. The integrated circuit as claimed in claim 16, wherein the controller unit controls the voltage on the power supply line, the voltage on the power supply line being controlled by supplying additional current to the power supply line from an external source.
